(19) United States
(12) Patent Application Publication
(10) Pub. No.: US 2015/0054512 A1
(43) Pub. Date: Feb. 26, 2015

(54) DIELECTRIC SPECTROSCOPY FOR FILTRATE CONTAMINATION MONITORING DURING FORMATION TESTING

(71) Applicant: Rocco DiFoggio, Houston, TX (US)

(72) Inventor: Rocco DiFoggio, Houston, TX (US)

(73) Assignee: BAKER HUGHES INCORPORATED, Houston, TX (US)

(21) Appl. No.: 13/971,255

(22) Filed: Aug. 20, 2013

(51) Int. Cl. G01V 3/12; E21B 49/02

(52) U.S. Cl. CPC G01V 3/12; E21B 49/02
USPC 324/324

(57) ABSTRACT

An apparatus for estimating a volume fraction of a formation fluid in a sample having a filtrate contaminant includes: a carrier configured to be conveyed through a borehole; a downhole fluid extraction device disposed at the carrier and configured to extract a sample of a formation fluid through a wall of the borehole; and a dielectric spectrometer and configured to transmit electromagnetic energy into the extracted sample at a plurality of frequencies and to measure a plurality of responses to determine a permittivity of the extracted sample fluid as a function of frequency. The apparatus further includes a processor configured to receive the permittivity of the extracted sample as a function of frequency from the dielectric spectrometer and to estimate the volume fraction of the formation fluid using a permittivity at a selected frequency in the plurality of frequencies for the sample as measured by the dielectric spectrometer.

### BACKGROUND OF THE INVENTION

Exploration and production of hydrocarbons require accurate and precise measurements of earth formations, which may contain reservoirs of the hydrocarbons. Accurate and precise measurements are important to enable efficient use of exploration and production resources.

Well logging is a technique used to perform measurements of an earth formation from within a borehole penetrating the formation. In well logging, a downhole instrument or tool is conveyed through the borehole. The downhole instrument performs the measurements from within the borehole at various depths typically using a sensor. The measurements are associated with the depth at which the measurements were performed to create a log. In one embodiment, a wireline is used to support the downhole instrument and to transmit measurements to the surface of the earth for processing and recording.

Many types of measurements can be made of the earth formation. In one type of measurement, a formation tester extracts a sample of a fluid from the formation. Unfortunately, mud filtrate (the liquid portion of the drilling mud or fluid) inevitably enters pores of the rock and, when miscible with the connate (original) fluid, mixes with it and contaminates it, compromising the fluid sample that one is trying to collect. Miscibility of filtrate with the fluid sample occurs when trying to collect an oil sample in a well that was drilled with an oil based mud. The fluid being pumped from the formation is analyzed in real time downhole using, for example, an optical spectrometer to estimate whether it seems or appears clean (i.e., uncontaminated) enough to be collected into a sample tank for subsequent analysis by a PVT (pressure-volume-temperature) laboratory at the surface.

Traditionally, a filtrate contamination level of less than 10% was required because above that contamination level, any subsequent surface PVT laboratory analysis has a high level of uncertainty, which caused high uncertainty n estimation of reserves, estimation of production rates, compartmentalization analysis, reservoir connectivity analysis, flow assurance, and design of well completion and facilities. Ideally, oil companies would like to have as low a contamination level as possible, and preferably zero contamination. To minimize contamination, oil companies have often pumped fluid from the formation for an hour or two because contamination generally declines with prolonged pumping or, alternatively, they may use a more expensive probe and guard system for pumping. Some oil companies have pumped for up to 10 to 12 hours just to be on the safe side, which corresponds to a very expensive sample in rig time alone and not counting service company charges to deploy a downhole tool to collect the sample.

The current methods of estimating in real time when a sample is clean enough to collect into a sample tank (rather than disposing of it by pumping it into the wellbore) are based on downhole optical spectra, fluid sound speed, or other measured parameters leveling off (i.e., no longer changing significantly) or upon the fraction of the way that the present value is to the forecasted ultimate (asymptotic) value. It is noted that, currently, the contamination level is inferred rather than directly measured. However, unchanging measurements could be the result of a dynamic equilibrium between horizontal clean up and recontamination by filtrate coming from above and below the zone being tapped and not necessarily be due to having reached 100% purity connate fluid. Despite many hours of pumping and almost unchanging measured response when withdrawing oil from the center of a long column of an oil-filled highly permeable sand, some samples have had 30% contamination based on subsequent PVT laboratory gas chromatography. Hence, it would be well received in the drilling industry if apparatus and method were developed to directly measure the percentage of mud filtrate contamination in real time while pumping and, in particular, if the apparatus and method would provide the necessary accuracy in the high temperature environment downhole.

### BRIEF SUMMARY OF THE INVENTION

Disclosed is an apparatus for estimating a volume fraction of a formation fluid in a sample having a filtrate contaminant. The apparatus includes: a carrier configured to be conveyed through a borehole penetrating an earth formation; a downhole fluid extraction device disposed at the carrier and configured to extract a sample of a formation fluid through a wall of the borehole; a dielectric spectrometer disposed at the carrier and configured to transmit electromagnetic energy into the extracted sample at a plurality of frequencies and to measure a plurality of responses to determine a permittivity of the extracted sample fluid as a function of frequency; and a processor configured to receive the permittivity of the extracted sample as a function of frequency from the dielectric spectrometer and to estimate the volume fraction of the formation fluid using a permittivity at a selected frequency in the plurality of frequencies for the sample as measured by the dielectric spectrometer.

Also disclosed is an apparatus for obtaining a sample of a formation fluid having a filtrate contaminant. The apparatus includes: a carrier configured to be conveyed through a borehole penetrating an earth formation; a downhole fluid extraction device disposed at the carrier and configured to extract a sample of a formation fluid through a wall of the borehole; a dielectric spectrometer disposed at the carrier and configured to transmit electromagnetic energy into the extracted sample at a plurality of frequencies and to measure a plurality of responses to determine a permittivity of the extracted sample fluid as a function of frequency; a processor configured to receive the permittivity of the extracted sample as a function of frequency and to estimate the volume fraction of the formation fluid using a permittivity at a selected frequency in the plurality of frequencies for the sample as measured by the dielectric spectrometer; a sample tank configured to contain the extracted sample; and a controller configured to receive the volume fraction from the processor and to transmit a control signal to the downhole fluid extraction device to stop extracting formation fluid when the volume fraction meets or exceeds a selected setpoint.

Further disclosed is a method for estimating a volume fraction of a formation fluid in a sample having a filtrate contaminant. The method includes: conveying a carrier through a borehole penetrating an earth formation; extracting a sample of a formation fluid through a wall of the borehole using a downhole fluid extraction device disposed at the carrier; determining a permittivity of the extracted sample as a function of frequency using a dielectric spectrometer disposed at the carrier and configured to transmit electromagnetic energy into the extracted downhole fluid at a plurality of frequencies and to measure a plurality of responses comprising electromagnetic energy due to the transmitting to measure the permittivity as a function of frequency; and estimating the volume fraction of the formation fluid using a permittivity for the sample at a selected frequency in the plurality of frequencies as measured by the dielectric spectrometer.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a downhole tool disposed in a borehole penetrating the earth;

FIG. 2 depicts aspects of a dielectric spectrometer disposed at the downhole tool;

FIG. 3 depicts aspects of another dielectric spectrometer disposed at the downhole tool;

FIG. 4 illustrates the real and imaginary components of complex permittivity as a function of frequency for one particular grade of crude oil;

FIG. 5 illustrates the real and imaginary parts of complex permittivity as a function of frequency for three different crude oils extracted from three different regions;

FIG. 6 illustrates the real and imaginary components of complex permittivity of water as a function of frequency;

FIG. 7 illustrates the real part of the complex permittivity as a function of frequency for three different oil-based drilling fluids;

FIG. 8 illustrates the imaginary part of complex permittivity as a function of frequency for the same three different oil-based drilling muds represented in FIG. 7;

FIG. 9 illustrates the relative permittivity (real part) as a function of frequency for several oil-based drilling fluid samples that were either laboratory prepared or randomly selected from the field;

FIG. 10 illustrates the relative permittivity as being a function of temperature;

FIG. 11 depicts aspects of a controller for controlling pumping of a fluid sample from the earth; and

FIG. 12 is a flow chart for a method for estimating a volume fraction of a formation fluid in a sample having a filtrate contaminant.

### DETAILED DESCRIPTION OF THE INVENTION

Disclosed are exemplary embodiments of apparatus and method for estimating a volume fraction of a formation fluid in a sample having a filtrate contaminant. The apparatus and method call for conveying a fluid extraction tool in a borehole penetrating an earth formation of interest containing a formation fluid. The fluid extraction tool is configured to extract a sample of the formation fluid through the borehole wall. Upon obtaining the sample, which may be a mixture of formation fluid and filtrate contaminate, a dielectric spectrometer measures a permittivity (also referred to as a dielectric constant) of the fluid as a function of frequency. From the measured permittivity as a function of frequency, the volume fraction of the formation fluid and/or the volume fraction of the filtrate contaminant may be determined. Based upon the measured contamination percentage, the operator can decide whether the fluid sample has reached sufficient purity to be collected into a sample tank, thus saving the high cost of unnecessary rig time. Alternatively, once the volume fractions of the various components of the sample are determined, a correction may be applied to any measurements performed on or inferred for the sample so as to correct for the remaining amount of contamination, thereby improving the accuracy of the measurements.

Permittivity is a measure of the ability of a material to polarize in response to an electric field and, thereby, reduce the total electric field inside the material. In addition, the permittivity of a material is a quantity used to describe the material's dielectric properties that influence reflection of electromagnetic waves at interfaces and the attenuation of wave energy within the material. Hence, in a non-limiting embodiment, the permittivity of a material can be determined by measuring the polarization of the material in response to an applied electric field or, in another non-limiting embodiment, by measuring reflection of electromagnetic waves by the material and wave energy dissipation in the material.

The permittivity, in the frequency domain, is generally a complex number with the real part corresponding to the energy stored during polarization and the imaginary part corresponding to the energy dissipated during polarization and it can be measured in several ways. One way is to apply an alternating current or field (AC) voltage to the sample using two electrodes that form a configuration similar to that of a capacitor. The resulting electrical current flowing through the sample is measured. The permittivity is then derived from the in-phase current and the out-of-phase current. The frequency of the applied voltage is generally in the radio-frequency range and, thus, it avoids the need for a typical optical photodetector with its inherent disadvantages in a high-temperature environment.

Another way to measure permittivity is to dispose the sample in a waveguide and subject the sample to radio-frequency (RF) electromagnetic (EM) waves emitted from a transducer or antenna. The resulting EM waves reflected by the sample and transmitted through the sample are measured. From the reflected EM wave measurements and the transmitted EM wave measurements, the permittivity of the sample can be derived.

A wide range of molecules and atoms can make up a formation fluid. These molecules and atoms can have polar structures, which are affected by electric fields. In general, the polar structures can have different masses and structures that are affected uniquely by AC electromagnetic energy of a certain frequency transmitted into the formation fluid. Examples of responses of the atoms and/or molecules to electromagnetic waves include vibration, rotation, displacement, and dipole inducement. At radio frequencies, rotation of existing polar molecules is the primary response whereas at optical frequencies, the vibrational modes of atoms within molecules are the primary response. The frequency dependence of the formation fluid depends on how well a polar molecule can reorient itself in response to a varying electromagnetic field. If the polar molecule has a high moment of inertia or it is viscously coupled to neighboring molecules, then its largest response will be at frequencies lower (because it cannot reorient itself fast enough before the field has reversed direction) than the frequencies if that polar molecule had a small moment of inertia and was not viscously coupled to neighboring molecules. Hence, some aspects of the chemical composition of the formation fluid can be identified by transmitting electromagnetic energy into the sample of the fluid at a plurality of frequencies and measuring resulting responses. In particular, the magnitude and/or phase of a response may be increased at a resonant frequency and the chemical composition can be identified by determining the frequencies where the resonances occur.

Because a response includes detecting electric or electromagnetic energy having a magnitude and phase with respect to the transmitted electromagnetic energy, the permittivity is represented as a complex number having a real component (i.e., the dielectric constant) and an imaginary component. In one embodiment, the real component relates to energy stored within the formation fluid when the fluid is exposed to an electric field and the imaginary component relates to the dissipation of energy (i.e., absorption and attenuation) within the formation fluid. Equation (1) provides a mathematical representation of permittivity “ε” as a complex number where ε′ represents the real component, ε″ represents the imaginary component, and ω is the angular frequency.

ε(ω)=ε′(ω)+iε″(ω) (1)

Equation (1) may be rewritten as equation (2) where D₀ is the magnitude of the electric displacement field, ε₀ is the magnitude of the electric field, and δ is the phase difference between D₀ and ε₀.

ε(ω)=(D₀/E₀)(cos δ+i sin δ) (2)

Non-limiting embodiments of formation fluids of interest to petro-analysts include oil, water, and natural gas. Natural gas is composed almost entirely of nonpolar compounds (e.g., methane, ethane, propane, butane, etc.) and has few if any polar compounds such as asphaltenes. In crude oils, here are many polar compounds, especially asphaltenes, which lead to dielectric dispersions (i.e., changes in dielectric constant with frequency). For crude oils, the imaginary component e″ of permittivity is generally around 0.01 to 0.02 over a frequency range of 1 MHz to 100 MHz with the peaks being around 0.04 at 20 MHz and 0.12 to 0.16 at 1.5 KHz to 30 KHz. These peaks are an indication of the amount of asphaltenes and the associated polar resins and maltenes in the crude oil where maltenes are the pentane soluble portions of a crude oil, resins are pentane insoluble but heptane soluble portions, and asphaltenes are heptane insoluble portions. Over most of the frequency range, crude oil (with a real dielectric constant of 2.2 to 2.6) can be discriminated from water (with a real dielectric constant of approximately 78 at room temperature and lower at elevated temperature). Thus, by measuring the amount of asphaltenes in a sample of crude oil, the quality of the sample can be classified as light, medium or heavy oil. Use of higher frequencies such as 1 GHz can allow easy discrimination of oil (with a dielectric constant of approximately 2) compared to water (with a dielectric constant of approximately 80). By detecting changes in the chemical identity of the formation fluid with depth, a location of a boundary between formation layers can be identified.

For convenience, certain definitions are now presented. The term “radio-frequency” relates to frequencies below frequencies of light such that a photodetector is not required for detection or quantification of a received signal in the frequency range of interest. The term “dielectric spectrometer” relates to apparatus for measuring a dielectric constant of a formation fluid by transmitting electromagnetic energy into the fluid at a plurality of frequencies in order to determine the permittivity as a function of frequency. The frequencies are in a range of frequencies that correlate to resonances of materials that may be expected to be present in the fluid.

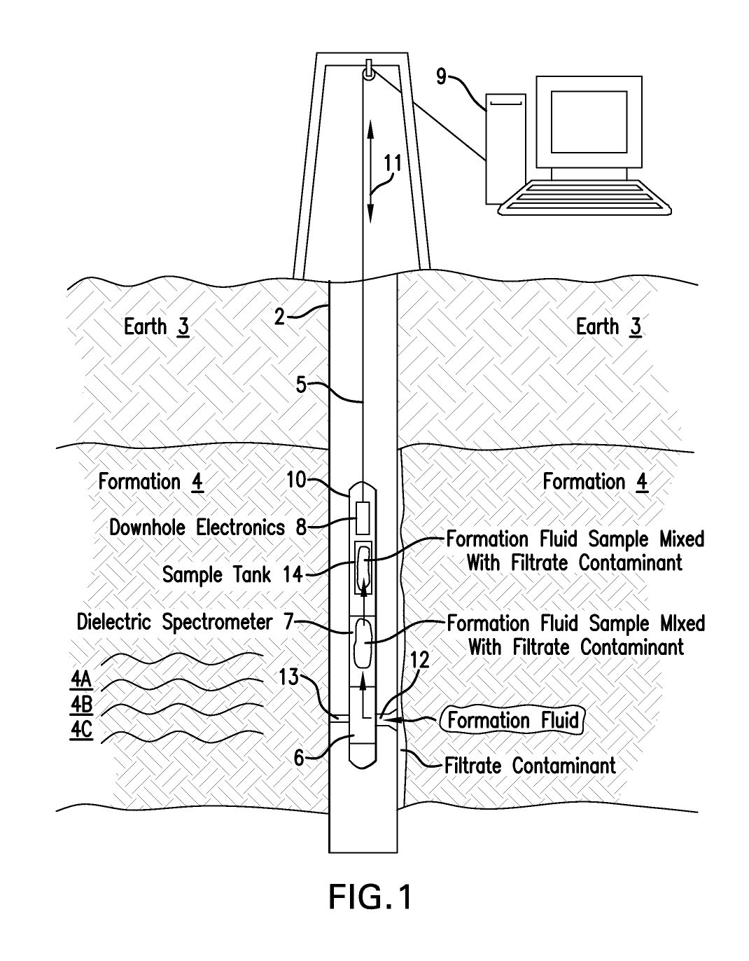

Reference may now be had to FIG. 1 illustrating an exemplary embodiment of a downhole tool 10 disposed in a borehole 2 penetrating the Earth 3. The earth 3 includes an earth formation 4 that includes layers 4A-4C, each layer having a property distinguishable from the property of another layer. As used herein, the term “formation” includes any subsurface materials of interest that may be analyzed to estimate a property thereof. The downhole tool 10 is supported and conveyed through the borehole 2 by an armored cable 5 in a technique referred to as wireline downhole. In addition to supporting the downhole tool 10, the wireline 5 can be used to communicate information between the downhole tool 10 and equipment at the surface of the Earth 3. In another technique referred to as downhole-while-drilling (LWD), the downhole tool 10 is disposed at a drill string or coiled tubing and is conveyed through the borehole 2 while the borehole 2 is being drilled. In LWD, the downhole tool 10 performs a measurement during a temporary halt in drilling.

Still referring to FIG. 1, the downhole tool 10 includes a formation fluid extraction device 6. The formation fluid extraction device 6 is configured to extract a sample of a fluid from the formation 4 through the wall of the borehole 2. The sample is then provided to a dielectric spectrometer 7 coupled to the fluid extraction device 6. The dielectric spectrometer 7 is configured to measure the dielectric constant or permittivity (i.e., real and complex parts) of the sample as a function of frequency to determine the resonant frequencies of the sample and, thus, some aspects of the chemical identity of the materials in the sample. In one or more embodiments, the dielectric spectrometer 7 performs measurements with electromagnetic energy at a plurality of frequencies on one batch of a sample at a time.

Still referring to FIG. 1, the formation fluid extraction device 6 includes a probe 12 configured to extend from the device 6 and form a seal to the wall of the borehole 2. In order to keep the device 6 in place while the seal is being formed, the device 6 includes a brace 13 configured to extend from the device 6 and contact the wall of the borehole 2 opposite of the location where the seal is being formed. After the seal is formed, pressure within the probe 12 is reduced to extract the fluid from the formation 4 through the borehole wall and into the device 6 from which it can be transferred to the dielectric spectrometer 7. Other types of measurements may also be performed using other types of tools or sensors (not shown). After the dielectric spectrometer 7 measures the permittivity of the sample and the volume fraction of the formation fluid and/or filtrate contaminant is determined, the sample may be disposed in a sample tank 14. The sample tank 14 is configured to contain the sample at reservoir conditions so that the sample may be retrieved at the surface for analysis in a laboratory.

Still referring to FIG. 1, the downhole tool 10 includes a downhole electronics unit 8. The downhole electronics unit 8 can be configured to operate the downhole tool 10 and/or communicate data 11 between the downhole tool 10 and a surface computer processing unit 9.

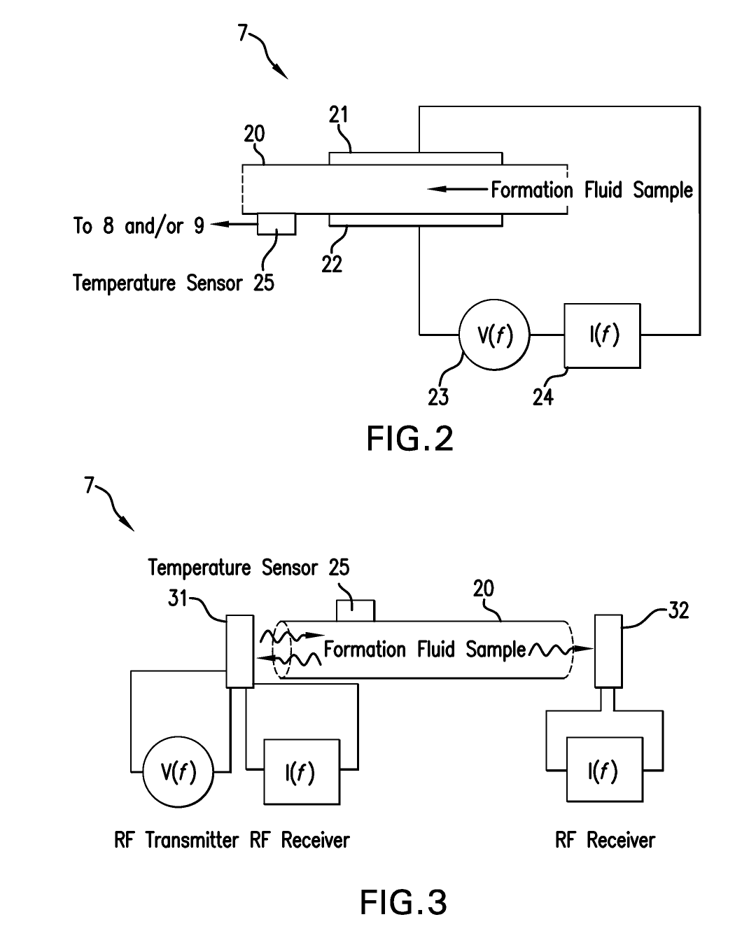

Reference may now be had to FIG. 2 depicting aspects of one embodiment of the dielectric spectrometer 7. The dielectric spectrometer 7 includes a receiver 20 (also referred to as a test cell) configured to receive the sample of the formation fluid from the formation fluid extraction device 6. The receiver 20 includes a first electrode 21 and a second electrode 22 coupled to a variable frequency voltage source 23 configured to apply a voltage V(ω) to the electrodes 21, 22 at a plurality of radio-frequencies. A current analyzer 24 measures the magnitude and phase of the current I (ω) flowing through the sample with respect to the applied voltage V(ω). It can be appreciated that the electric energy flowing though the sample in the test cell at an alternating current frequency may also be referred to as electromagnetic energy.

Because complex permittivity is generally dependent of temperature, a temperature sensor 25 may be thermally coupled to or in thermal communication with the formation fluid sample. Output from the temperature sensor 25 may be input into the downhole electronics 8 and/or the computer processing system 9 for data processing to determine the volume fractions of the components of the sample.

Reference may now be had to FIG. 3 depicting aspects of another embodiment of the dielectric spectrometer 7. In this embodiment, the receiver 20 is a waveguide configured to hold the sample while receiving electromagnetic energy at a plurality of radio-frequencies from a first transducer 31. A second transducer 32 is configured to receive electromagnetic energy passing through the sample. A third transducer or the first transducer 31 in a receiving mode can be configured to receive electromagnetic energy reflected by the sample. Using magnitudes and phase relationships of the transmitted-to-sample, reflected-from-sample, and transmitted-through-sample electromagnetic energy, the permittivity as a function of frequency can be determined. In-phase current with respect to the applied voltage may be used to obtain the real part of the complex permittivity, while the out-of-phase current with respect to the applied voltage may be used to obtain the imaginary part of the complex permittivity. Exemplary embodiments of the transducers 31 and 32 include antennas or coils. Similar to the configuration of FIG. 2, the temperature sensor 25 in FIG. 3 is in thermal communication with the sample in the wave guide and provides a measurement of the temperature of the sample for data processing to determine the volume fractions of the components of the sample.

In one or more embodiments, the plurality of frequencies at which electromagnetic energy is transmitted into the sample includes a plurality of discrete frequencies. The number or discrete frequencies is selected to provide a smooth curve of permittivity versus frequency with enough resolution to illustrate any resonances along the range of frequencies. Because of the wide range of frequencies, the frequency axis of curve may be presented as a logarithm. In one or more embodiments, 20 to 21 discrete frequencies per interval (each interval representing an order of magnitude of frequency) are selected to provide a curve of permittivity versus frequency for the real and imaginary parts of the permittivity.

To a first approximation, the permittivity of a sample (εₛₐₘₚₗₑ) made up of a mixture of a formation fluid, such as crude oil, and a filtrate contaminate, such as oil-based drilling fluid filtrate, for a selected frequency may be expressed by a volumetric mixing law as:

ε_{Sample}=[Vf_{formation fluid}×ε_{formation fluid}]+[Vf_{filtrate contaminant}×ε_{filtrate contaminant}] (1)

where Pₛₐₘₚₗₑ represents the permittivity of the sample at the selected frequency, Vf_{formation fluid} represents the volume fraction of the actual formation fluid, ε_{formation fluid} represents the permittivity of the formation fluid at the selected frequency, Vf_{filtrate contaminant} represents the volume fraction of the filtrate contaminate, and P_{filtrate contaminant} represents the permittivity of the filtrate contaminate at the selected frequency.

By knowing the permittivity of the formation fluid alone and the permittivity of the filtrate contaminant alone at the selected frequency in addition to knowing that the sum of the volume fractions equals one (Vf_{formation fluid}+Vf_{filtrate contaminant}=1), the volume fraction of the formation fluid (Vf_{formation fluid}) can be solved for in Equation (1) above. The composition of the formation fluid alone may already be known and, thus, the permittivity of the formation fluid as a function of frequency ε (ω) may already be known from previous laboratory testing or analysis of a similar formation fluid such as obtained from a nearby well. If not previously known, then a sample of the formation fluid may be tested or analyzed in a laboratory to determines ε (ω). Similarly, the composition of the filtrate contaminant may already be known because the composition of the drilling fluid may already be known. Accordingly, the permittivity of the filtrate contaminate may already be known from previous laboratory testing or analysis. If not previously known, then a sample of the filtrate contaminant may be tested or analyzed in a laboratory to determine ε (ω). The volume fraction of the formation fluid may be solved for as in Equation (2).

Vf_{formation fluid}=[ε_{Sample}−ε_{formation fluid}]/[ε_{formation fluid}−ε_{filtrate contaminant}] (2)

The volume fraction of the filtrate contaminant may be solved for as in Equation (3).

Vf_{filtrate contaminant}=[ε_{Sample}−ε_{formation fluid}]/[ε_{filtrate contaminant}−ε_{formation fluid}] (3)

It can be appreciated that calculating one of the volume fractions inherently includes calculating the other volume fraction knowing that their sum equals one.

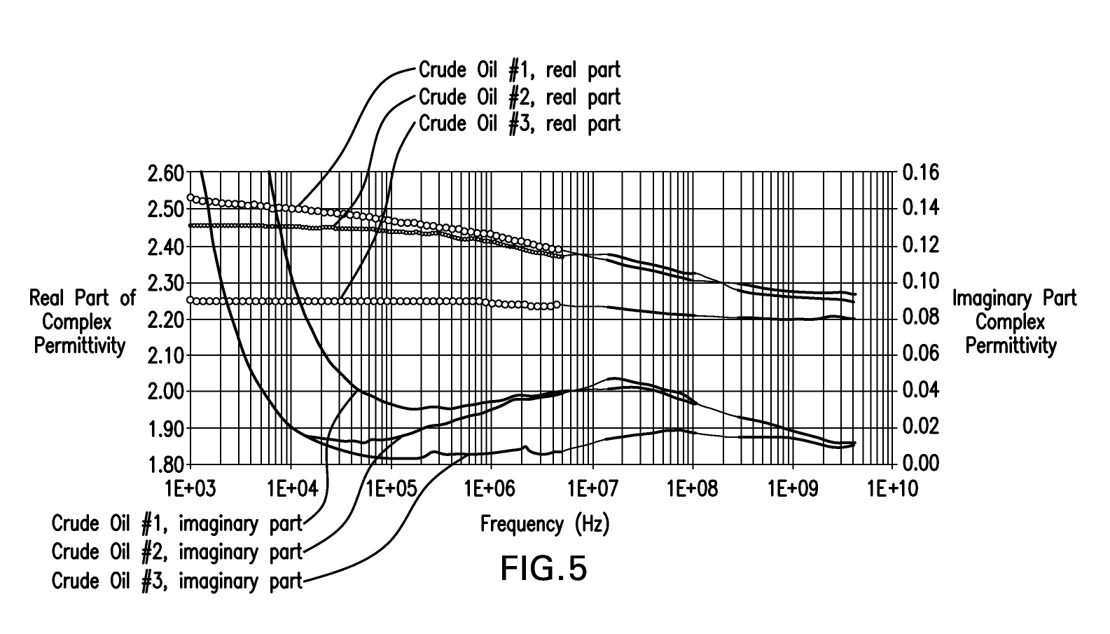

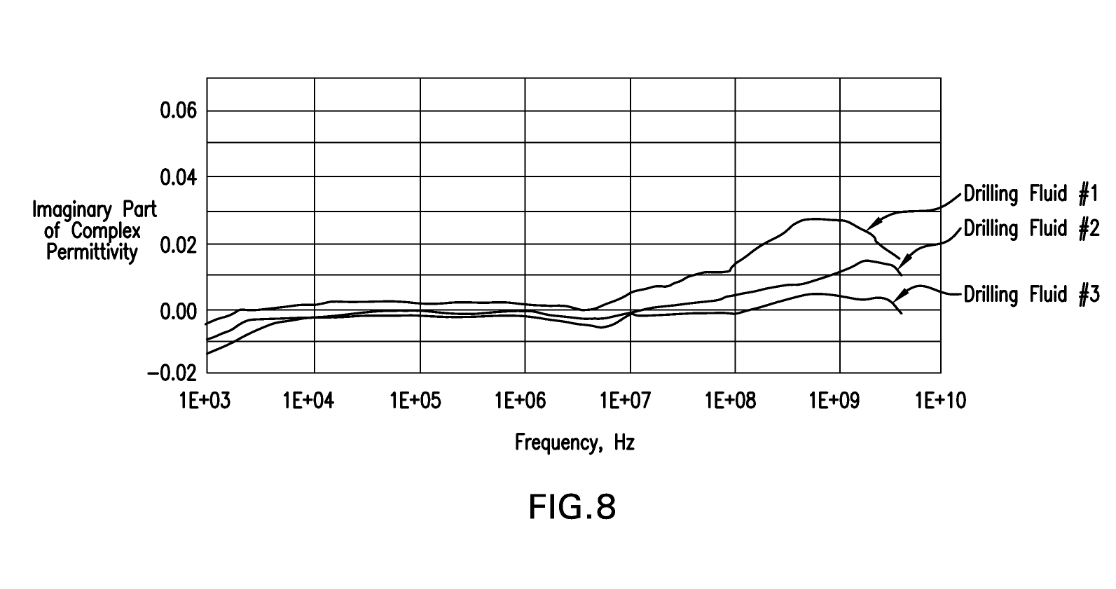

Alternatively, a frequency may be determined at which all crude oils have approximately (e.g., +/−5%) the same real or imaginary dielectric value or slope and at which all filtrates have approximately the same real or imaginary dielectric value or slope but the filtrate value is different from the crude oil value. Then, there is sufficient contrast between the two groups upon which to base a quantification of how much of each is in a mixture. For example, at 400 MHz, it appears that crude oils have a positive imaginary dielectric slope of approximately 1.67E-11/Hz (FIG. 5) whereas filtrates have a negative imaginary dielectric slope of approximately −3.70E-11/Hz (FIG. 8). Hence a generic value may be used for crude oil and another generic value may be used for the filtrate contaminant without requiring knowledge of the permittivity of the specific crude oil and the permittivity of the specific filtrate contaminant. The same dielectric value or slope for each component of the sample at a specific frequency is an example of an invariant that allows equations (2) and (3) to be solved for that specific frequency using generic values for the permittivities.

In yet another alternative, more sophisticated methods such as chemometrics (multiple linear regression, principal components regression, partial least squares, neural networks, and so on) on a training set of known mixtures of various crude oils with various filtrates may be employed to develop a contamination percentage equation that is independent of the particular crude oil and the particular filtrate in the mixture.

In equation (1) above, each of the permittivities at the selected frequency may be the real component of the permittivity, the imaginary component of the permittivity, or the complex permittivity (i.e., the vector sum of the real and imaginary components).

In general, the frequency at which the permittivities are selected for use in Equation (1) is selected such that the difference between the permittivity of the formation fluid and the permittivity of the filtrate contaminant is maximized. Increased separation between ε_{formation fluid} and ε_{filtrate contaminant} provides for increased signal to noise ratio, thereby providing a more accurate estimation of Vf_{formation fluid}.

It can be appreciated that there may be more than one filtrate contaminant present downhole if the drilling fluid is changed during drilling. For these situations, the filtrate contaminant components may be tested or analyzed in a mixture having a known ratio of the different filtrate contaminants. Alternatively, the filtrate contaminant components in Equation (1) can be expanded to include multiple filtrate contaminants. As long as the volume ratios of the separate contaminants are known with respect to each other, Equation (1) can be solved to determine the volume fraction of the formation fluid. Of course, if one uses a contamination percentage equation that has little or no sensitivity to which filtrate is in the mixture, then there is correspondingly little concern about how many filtrate contaminants are in the mixture.

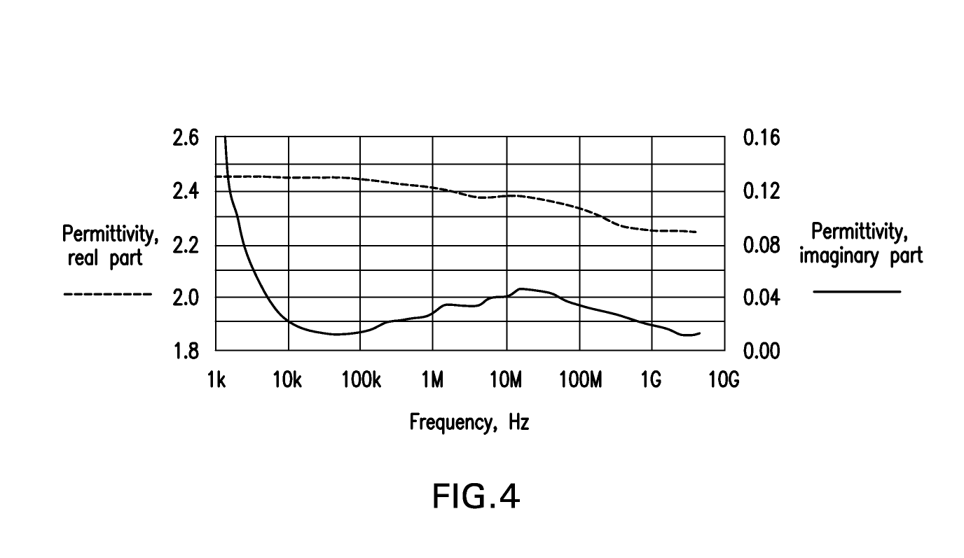

Examples of the real component and the imaginary component of complex permittivity as a function of frequency for different grades of crude oil are presented in FIGS. 4 and 5. FIG. 4 illustrates the real and imaginary components of complex permittivity as a function of frequency for one particular grade of crude oil. FIG. 5 illustrates the real and imaginary parts of complex permittivity as a function of frequency for three different crude oils extracted from three different regions.

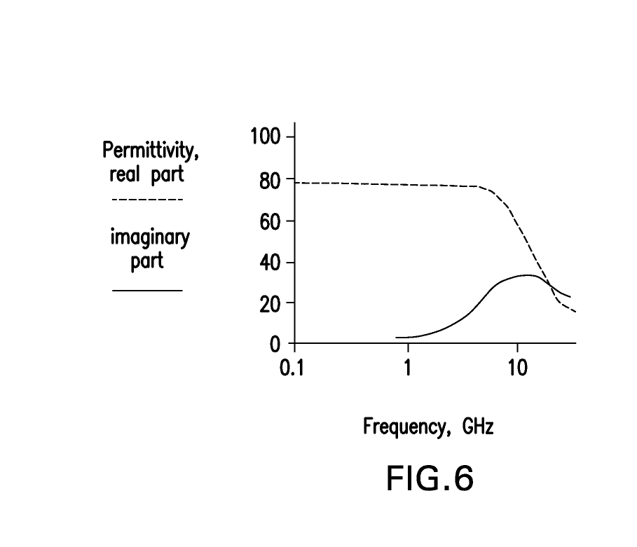

FIG. 6 illustrates the real and imaginary components of complex permittivity of water as a function of frequency. One or both of these components at a selected frequency may be used in Equation (1) when water is a miscible filtrate contaminant during collection of a downhole brine sample in a well drilled with water-based mud (i.e., drilling fluid).

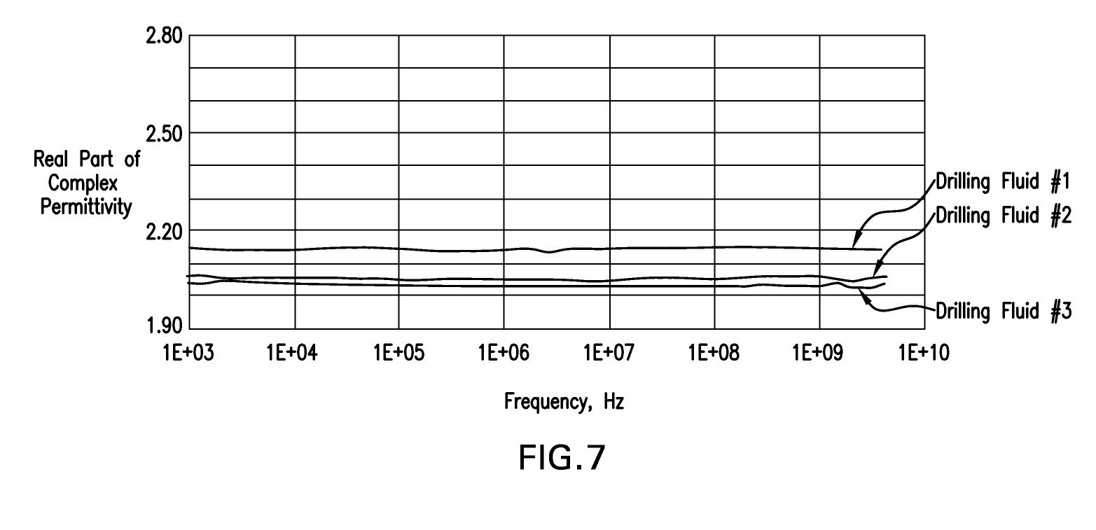

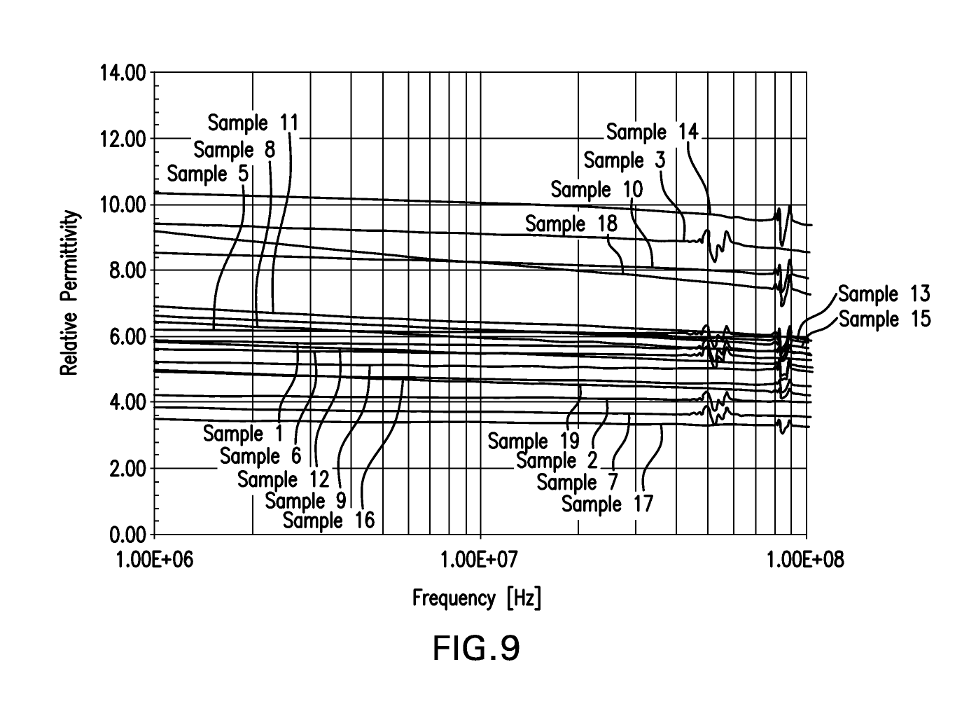

Other filtrate contaminants may include the drilling fluid. One example of the drilling fluid is an oil-based drilling fluid. FIG. 7 illustrates the real part of the complex permittivity as a function of frequency for three different oil-based drilling fluids. FIG. 8 illustrates the imaginary part of complex permittivity as a function of frequency for the same three different oil-based drilling muds represented in FIG. 7. FIG. 9 illustrates the relative permittivity (real part) as a function of frequency for several oil-based mud samples that were either laboratory prepared or randomly selected from the field. The relative permittivity in FIG. 9 represents the real part of the permittivity relative to the permittivity of free space.

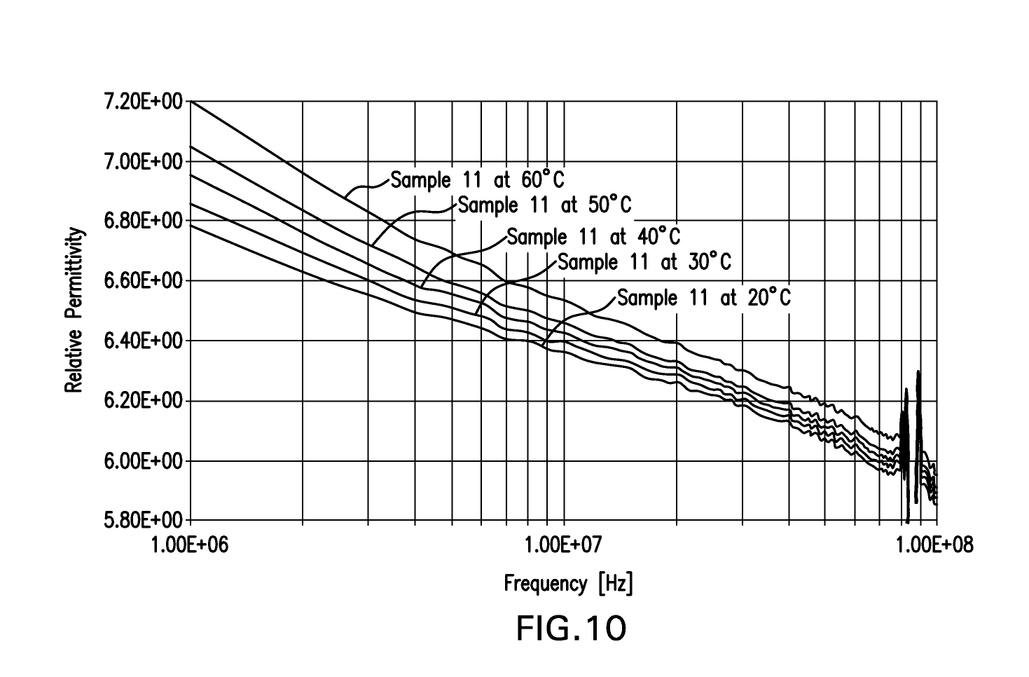

As illustrated in FIG. 10, permittivity is also a function of temperature. The sample in FIG. 10 is an oil-based mud sample illustrated in FIG. 9 as Sample 11. Hence, the temperature sensor 25 may be used to measure the temperature of the sample in the test cell or the wave guide so that the permittivities at the selected frequency to be input into Equation (1) can be selected from reference data corresponding to the same temperature as the sample. The relative permittivity in FIG. 10 represents the real part of the permittivity relative to the permittivity of free space. Temperature can be accounted for explicitly by a temperature measurement or implicitly by measuring dielectric spectra of an entire training set of known contamination fraction samples at a variety of temperatures. Regressing this multiple-temperature training set for contamination percentage produces an equation that implicitly corrects for temperature and has low sensitivity to temperature variations.

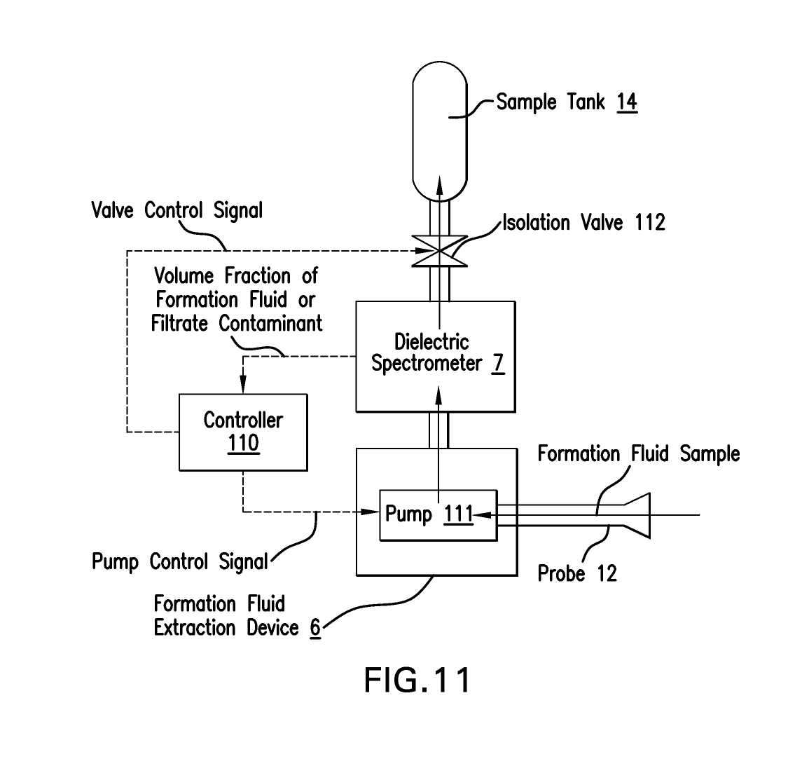

FIG. 11 depicts aspects of a controller 110 coupled to a pump 111 that is configured to pump the formation fluid through the borehole wall using the probe 12. The controller 110 receives a signal having the volume fraction of the formation fluid or the volume fraction of the filtrate contaminant in the sample. The controller 110 is configured to turn the pump 111 off or to isolate the latest sample in the sample tank 14 (such as by operating valve 112) when either the volume fraction of the formation fluid meets or exceeds a selected setpoint (e.g., 90% or 95%) and/or when the volume fraction of the filtrate contaminant is less than or equal to another selected setpoint (e.g., 10% or 5%). It can be appreciated that the controller 110 may be implemented as a standalone component, by the downhole electronics 8, or the surface computer processing system 9.

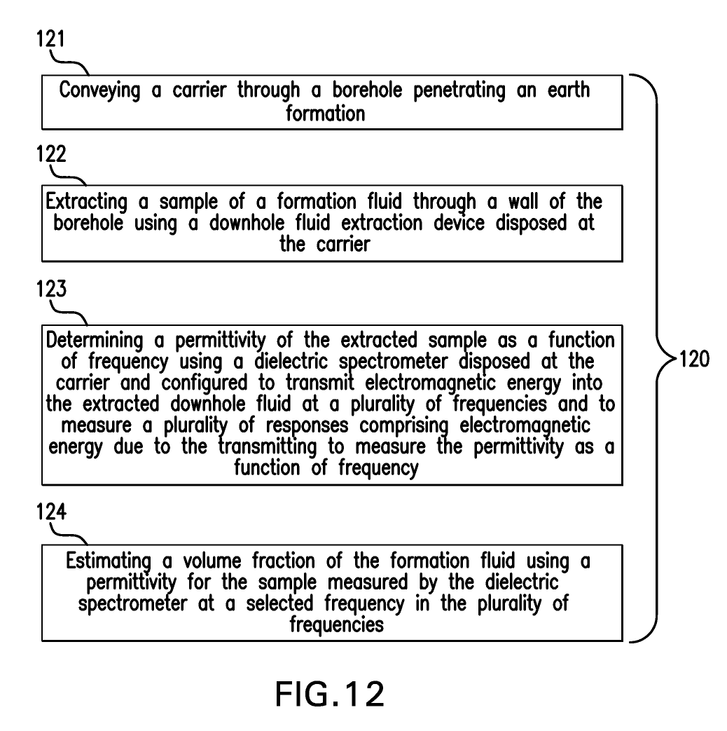

FIG. 12 is a flow chart for a method 120 for estimating a volume fraction of a formation fluid in a sample having a filtrate contaminant. Block 121 calls for conveying a carrier through a borehole penetrating an earth formation. Block 122 calls for extracting a sample of a formation fluid through a wall of the borehole using a downhole fluid extraction device disposed at the carrier. Block 123 calls for determining a permittivity of the extracted sample as a function of frequency using a dielectric spectrometer disposed at the carrier and configured to transmit electromagnetic energy into the extracted downhole fluid at a plurality of frequencies and to measure a plurality of responses comprising electromagnetic energy due to the transmitting to measure the permittivity as function of frequency. Block 124 calls for estimating the volume fraction of the formation fluid using a permittivity for the sample at a selected frequency in the plurality of frequencies as measured by the dielectric spectrometer. Block 124 may also call for using a permittivity of the formation fluid at the selected frequency and a permittivity of a contaminant material in the filtrate contaminant at the selected frequency to estimate the volume fraction. The permittivity of the formation fluid may be a generic value such as a generic value for crude oil and the permittivity if the contaminant material may be a generic value such as for a type of drilling fluid. The method 120 may also include measuring a temperature of the sample using a temperature sensor and selecting the permittivity of the formation fluid and the permittivity of the contaminant material so that these permittivities correspond to the measured temperature. The method 120 may also include stopping extracting formation fluid (such as by stopping the pump) or isolating a latest sample when the volume fraction of the formation fluid meets or exceeds a selected setpoint (or, conversely, when a calculated volume fraction of the filtrate contaminant meets or is less than a selected setpoint).

In support of the teachings herein, various analysis components may be used, including a digital and/or an analog system. For example, the downhole electronics 8, the surface computer processing system 9, the dielectric spectrometer 7, or the controller 110 may include the analog or digital system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a non-transitory computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a sample line, sample pump, power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

A “formation fluid” as used herein includes any gas, liquid, flowable solid and other materials having a fluid property that contained in an earth formation or reservoir in an earth formation.

The term “carrier” as used herein means any device, device component, combination of devices, media and/or member that may be used to convey, house, support or otherwise facilitate the use of another device, device component, combination of devices, media and/or member. The downhole tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for estimating a volume fraction of a formation fluid in a sample having a filtrate contaminant, the apparatus comprising:
a carrier configured to be conveyed through a borehole penetrating an earth formation;
a downhole fluid extraction device disposed at the carrier and configured to extract a sample of a formation fluid through a wall of the borehole;
a dielectric spectrometer disposed at the carrier and configured to transmit electromagnetic energy into the extracted sample at a plurality of frequencies and to measure a plurality of responses to determine a permittivity of the extracted sample fluid as a function of frequency; and
a processor configured to receive the permittivity of the extracted sample as a function of frequency from the dielectric spectrometer and to estimate the volume fraction of the formation fluid using a permittivity at a selected frequency in the plurality of frequencies for the sample as measured by the dielectric spectrometer.

2. The apparatus according to claim 1 wherein the processor is further configured to use a permittivity of the formation fluid at the selected frequency and a permittivity of a contaminant material in the filtrate contaminant at the selected frequency to estimate the volume fraction of the formation fluid.

3. The apparatus according to claim 2, wherein the permittivity of the formation fluid at the selected frequency is a generic formation fluid permittivity and the permittivity of a contaminant material in the filtrate contaminant at the selected frequency is a generic contaminant material permittivity.

4. The apparatus according to claim 1, further comprising a temperature sensor configure to sense a temperature of the sample, wherein the processor is further configured to receive the permittivity of the formation fluid and the permittivity of a contaminant material in the filtrate contaminant corresponding to the measured sample temperature.

5. The apparatus according to claim 1, wherein the permittivity of the extracted sample is at least one of a real number and an imaginary number.

6. The apparatus according to claim 5, wherein the processor is configured to solve the following equation for the volume fraction of the formation fluid, Vf_{formation fluid}:
ε_{Sample}=[Vf_{Formation Fluid}×ε_{Formation Fluid}]+[Vf_{Filtrate Contaminant}×ε_{Filtrate Contaminant}]
where ε_{Sample} represents the permittivity of the sample at the selected frequency, ε_{Formation Fluid} represents the permittivity of the formation fluid at the selected frequency, Vf_{Filtrate Contaminant} represents the volume fraction of the filtrate contaminate, and ε_{Filtrate Contaminant} represents the permittivity of the filtrate contaminate at the selected frequency.

7. The apparatus according to claim 6, wherein ε_{formation fluid} and ε_{filtrate contaminant} are real numbers if εₛₐₘₚₗₑ is a real number and ε_{formation fluid} and ε_{filtrate contaminant} are imaginary numbers if εₛₐₘₚₗₑ is an imaginary number.

8. The apparatus according to claim 6, wherein εₛₐₘₚₗₑ, ε_{formation fluid} and ε_{filtrate contaminant} are complex numbers.

9. The apparatus according to claim 6, wherein the processor is further configured to use the equation, Vf_{formation fluid}+Vf_{filtrate contaminant}=1, to solve the equation in claim 2.

10. The apparatus according to claim 1, wherein the formation fluid is crude oil.

11. The apparatus according to claim 1, wherein the dielectric spectrometer comprises a transmitter configured to transmit the electromagnetic energy at the plurality of frequencies.

12. The apparatus according to claim 11, wherein the plurality of frequencies comprises a plurality of discrete frequencies.

13. The apparatus according to claim 1, wherein the dielectric spectrometer comprises a test cell configured to receive the sample and to perform the permittivity measurement.

14. The apparatus according to claim 13, wherein the test cell comprises a first electrode and a second electrode configured to contact the extracted fluid in the receiver, the first electrode and the second electrode being further configured to apply a voltage at a frequency and to measure the response.

15. The apparatus according to claim 1, wherein the dielectric spectrometer comprises at least one transducer configured to transmit radio waves into the extracted sample at the plurality of frequencies and/or to receive radio waves as the plurality of responses.

16. The apparatus according to claim 15, wherein the at least one transducer comprises a coil.

17. The apparatus of claim 1, wherein the plurality of frequencies of the transmitted electromagnetic energy is in a radio-frequency range.

18. The apparatus of claim 1, wherein the carrier is configured to be conveyed by at least one selection from a group consisting of a wireline, a slickline, a drill string, and coiled tubing.

19. An apparatus for obtaining a sample of a formation fluid having a filtrate contaminant, the apparatus comprising:
a carrier configured to be conveyed through a borehole penetrating an earth formation;
a downhole fluid extraction device disposed at the carrier and configured to extract a sample of a formation fluid through a wall of the borehole;
a dielectric spectrometer disposed at the carrier and configured to transmit electromagnetic energy into the extracted sample at a plurality of frequencies and to measure a plurality of responses to determine a permittivity of the extracted sample fluid as a function of frequency;
a processor configured to receive the permittivity of the extracted sample as a function of frequency and to estimate the volume fraction of the formation fluid using a permittivity at a selected frequency in the plurality of frequencies for the sample as measured by the dielectric spectrometer;
a sample tank configured to contain the extracted sample; and
a controller configured to receive the volume fraction from the processor and to transmit a control signal to the downhole fluid extraction device to stop extracting formation fluid when the volume fraction meets or exceeds a selected setpoint.

20. The apparatus according to claim 19, wherein the controller is further configured to transmit a control signal to an isolation valve configured to isolate the sample in the sample tank when the volume fraction meets or exceeds a selected setpoint.

21. A method for estimating a volume fraction of a formation fluid in a sample having a filtrate contaminant, the method comprising:
conveying a carrier through a borehole penetrating an earth formation;
extracting a sample of a formation fluid through a wall of the borehole using a downhole fluid extraction device disposed at the carrier;
determining a permittivity of the extracted sample as a function of frequency using a dielectric spectrometer disposed at the carrier and configured to transmit electromagnetic energy into the extracted downhole fluid at a plurality of frequencies and to measure a plurality of responses comprising electromagnetic energy due to the transmitting to measure the permittivity as a function of frequency; and
estimating the volume fraction of the formation fluid using a permittivity for the sample at a selected frequency in the plurality of frequencies as measured by the dielectric spectrometer.

22. The method according to claim 20, further comprising measuring a temperature of the sample using a temperature sensor, wherein the permittivity of the formation fluid, and the permittivity of a contaminant material in the filtrate contaminant correspond to the measured temperature.

23. The method according to claim 20, wherein the permittivity of the extracted sample is at least one of a real number and an imaginary number.

24. The method of claim 22, wherein estimating comprises solving the following equation for the volume fraction of the formation fluid, Vf_{formation fluid}:
εₛₐₘₚₗₑ=[Vf_{formation fluid}×ε_{formation fluid}]+[Vf_{filtrate contaminant}×ε_{filtrate contaminant}]
where εₛₐₘₚₗₑ represents the permittivity of the sample at the selected frequency, ε_{formation fluid} represents the permittivity of the formation fluid at the selected frequency, Vf_{filtrate contaminant} represents the volume fraction of the filtrate contaminate, and ε_{filtrate contaminant} represents the permittivity of the filtrate contaminate at the selected frequency.

25. The method according to claim 23, wherein ε_{formation fluid} and ε_{filtrate contaminant} are real numbers if εₛₐₘₚₗₑ is a real number and ε_{formation fluid} and ε_{filtrate contaminant} are imaginary numbers if εₛₐₘₚₗₑ is an imaginary number.

26. The method according to claim 23, wherein εₛₐₘₚₗₑ, ε_{formation fluid} and ε_{filtrate contaminant} are complex numbers.

27. The method according to claim 23, wherein solving comprises using the equation, Vf_{formation fluid}+Vf_{filtrate contaminant}=1, to solve the equation in claim 23.
